(19) United States
(12) Patent Application Publication
(10) Pub. No.: US 2005/0091340 A1
(43) Pub. Date: Apr. 28, 2005

(54) Processing interactive content offline

(75) Inventors: Michael D. Facemire, Cary, NC (US); Bert Lamb, Raleigh, NC (US); David M. Oliver, Pleasantville, NY (US); Michael Wanderski, Durham, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/677,046

(22) Filed: Oct. 1, 2003

(51) Int. Cl. G06F 15/16

(52) U.S. Cl. 709/218

(57) ABSTRACT

A method, system and apparatus for processing interactive content off-line in a dynamic system having transient addressability. A method for processing off-line interactive content in a dynamic system with variable addressability can include serving content for caching in a client device; generating a pathway navigation map (PNM) for the served content; and, annotating the served content with endpoint directives for modifying hyperlink behavior referenced by the directives in the cached content. In a preferred aspect of the invention, the generating step can include forming a document tree having a plurality of nodes; assigning each node of the tree to a document in the content accessible through a hyperlink referenced by a parent node; and, disposing within each node a set of hyperlink references to child pages in the content and a reference to a pathway to a root node of the document tree.

### BACKGROUND OF THE INVENTION

1. Statement of the Technical Field

The present invention relates to the field of content distribution and more particularly to offline content processing.

2. Description of the Related Art

The proliferation of pervasive computing devices and the increased demand for application access from these devices has forever changed the landscape of enterprise computing and content distribution. Prior to the advent of the functional pervasive computing device, it could be presumed that one would interact with a distributed application through the interface rendered within a traditional personal computer. Accordingly, it could be further presumed that a communicative coupling of adequate bandwidth and throughput could be maintained with the personal computer for an extended period of time if not perpetually. This presumption has given rise to various common enterprise application development techniques including session management or dynamic page rendering.

As the enterprise computing environment has become inundated with pervasive clients, and further as these pervasive clients supplant the traditional personal computer as an end user device through which the interface to a distributed application can be accessed, it no longer can be presumed that a persistent, wide bandwidth, high-throughput communicative coupling can be maintained. Notably, pervasive devices have become commonplace in the field within the context of data collection applications in which form based Web pages can be completed in the pervasive device and subsequently posted to a Web server either in batch mode, or in real-time over wireless communications link. Yet, whether in batch mode or in real-time, these communicative coupling techniques cannot guarantee the persistent and consistent nature of conventional network connectivity.

Thus, those who design distributed applications for distribution in pervasive devices must be able to deal with the fleeting connectivity inherent in this environment. To that end, several inherent obstacles must be overcome to adequately address the integration of pervasive device clients in a distributed application which enjoys, at best, a limited real-time communicative coupling. First, user session management has become an increasingly common way to enhance the overall user experience through personalization. Personalization often can be performed by adding a session token to the URL or as a request parameter as an internal part of the URL string itself. In consequence, however, URLs cannot be stored and re-used across multiple user sessions. Thus, one cannot programmatically access commonly used URLs deep within a Web site such as an “action” attribute within a <FORM> tag. In addition, portal servers also modify URLs across requests to maintain state for individual portlets.

Second, developers today create distributed applications tailored for individual users through the use of dynamic Web page construction methodologies. Technologies such as servlets and JSPs are now standard development tools within J2EE Web application servers. As a side effect of dynamic page construction, however, page content can change considerably over time. Examples include variable size lists, dynamic table dimensions, and the like. Thus, for an off-line system operating in batch mode, such as a pervasive device relying upon synchronization technologies to post form data, static content pathways become critical in ensuring that the correct data is posted to the server in an intelligible manner. While pathway crawling can be effective where the content of the site as cached off-line in the pervasive device can remain static, pathway crawling cannot be applied where the construction of a Web site is dynamic in nature.

Finally, Web site crawling for capturing content for off-line viewing in a pervasive device can impede effective off-line content interaction and on-line synchronization. For example, a hyperlink disposed within the content page that simply refreshes the content of the page is not useful, yet increases the amount of requests processed between a limited bandwidth connection between client and server during synchronization. Similarly, hyperlinks that sort list of entries may not be necessary because of the time and processing required to capture the new pages. Furthermore, a hyperlink for navigating to a parent document can cause the entire parent document to be captured again though it presumably had been captured previously.

### SUMMARY OF THE INVENTION

The present invention addresses the deficiencies of the art in respect to distributed off-line content management and provides a novel and non-obvious method, system and apparatus for processing interactive content off-line in a dynamic system having transient addressability. A method for processing off-line interactive content in a dynamic system with variable addressability can include serving content for caching in a client device; generating a pathway navigation map (PNM) for the served content; and, annotating the served content with endpoint directives for modifying hyperlink behavior referenced by the directives in the cached content.

In a preferred aspect of the invention, the generating step can include forming a document tree having a plurality of nodes; assigning each node of the tree to a document in the content accessible through a hyperlink referenced by a parent node; and, disposing within each node a set of hyperlink references to child pages in the content and a reference to a pathway to a root node of the document tree. In another preferred aspect of the invention, the annotating step can include annotating the content with at least one endpoint directive selected from the group consisting of take no action, remove all hyperlinks referenced by the directive, deactivate all hyperlinks referenced by the directive, point all hyperlinks referenced by the directive to a currently loaded page; and point all hyperlinks referenced by the directive to a parent page. In yet another preferred embodiment, the annotating step can include annotating the served content with at least one endpoint directive to invoke an action modifying all hyperlinks referenced by the directive when a specified depth within the content has been reached.

Notably, off-line submissions of content can be processed by navigating the PNM to reconcile on-line changes in hyperlinks in the content. In this regard, the processing step further can include the step of utilizing a specific element of the hyperlinks to reconcile ambiguities generated by changes in hyperlinks in the content. Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system for processing interactive off-line content;

FIG. 2A is a pictorial illustration of a pathway navigation map for use in the system of FIG. 1;

FIG. 2B is an exploded view of a node having a fragmented navigation set in the pathway navigation map of FIG. 2A;

FIG. 3A is a block diagram illustrating a process for capturing off-line content in the system of FIG. 1; and,

FIG. 3B is a block diagram illustrating a process of submitting interactive off-line content in the system of FIG. 1.

### DETAILED DESCRIPTION OF THE PREFERRED EMBODIMENTS

The present invention is a system, method and apparatus for processing interactive content off-line in a dynamic system with transient addressability. In accordance with the present invention, dynamically generated content intended for off-line interaction can be retrieved from a content server and annotated with a set of hyperlinks for additional content associated with the retrieved content. The retrieved content can be placed in a client-side cache and the additional content associated with the retrieved content further can be annotated with additional hyperlinks and stored in the client-side cache. Importantly, hyperlinks which can result in wasteful processing such as refresh hyperlinks and hyperlinks to parent documents can be disregarded through hidden directives written in concert with the annotations.

The process of retrieving, annotating and caching can continue until no more content remains to be retrieved and cached. Significantly, however, during the course of retrieving the dynamically generated content, a pathway navigation map (PNM) can be generated so as to map the interrelationships between a cached content set. Moreover, pattern matching techniques can be applied to address dynamic ambiguities in the arrangement and ordering of hyperlinks within content. In this way, despite subsequent changes in the structure and arrangement of the content set, content can be programmatically accessed within the structure of the set. More specifically, a hyperlink within content can be resolved within a content set regardless of the lack of directly hyperlink addressability over time. In any case, once stored in the cache, the content can be accessed off-line and data can be posted through the content for subsequent synchronization with the content server.

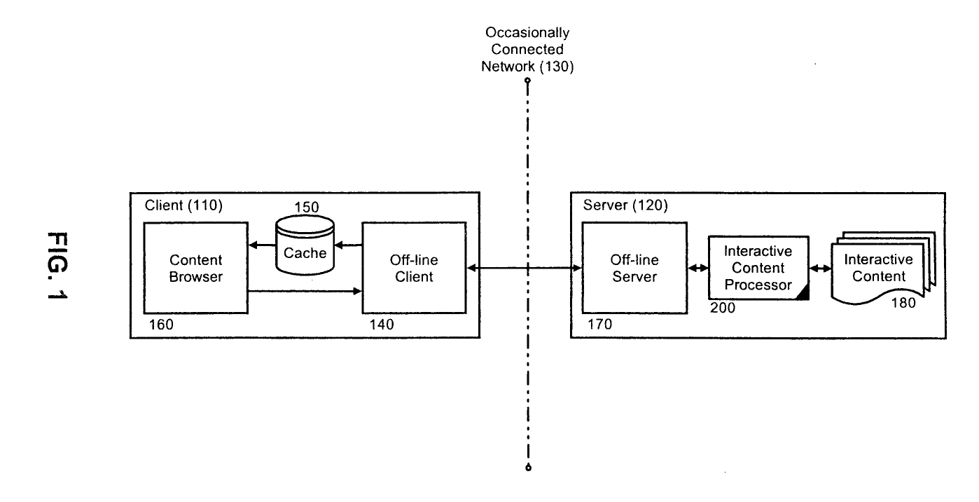

In more particular illustration of the present invention, FIG. 1 is a schematic illustration of a system for processing interactive off-line content. The system can include a client computing device 110 communicatively coupled in an intermittent and fleeting fashion with the server computing process 120 over the occasionally connected network 130. For instance, the client computing device 110 can be a pervasive device such as a personal digital assistant (PDA), cellular telephone, or laptop computer. In each case, it is presumed that the client computing device 110 does not enjoy as a matter of course, a persistent communicative link to the server computing process 120. The server computing process 120, in turn, can be a content server such as a Web application server.

The client computing device 110 can include a content browser 160 coupled to cache storage 150. Additionally, an off-line client process 140 can be disposed within the client computing device 110. In particular, the off-line client process 140 can be configured to retrieve dynamically generated content over the network 130 and to store the retrieved content in the cache storage 150. Moreover, the off-line client process 140 can handle off-line requests to access and interact with cached content as if the content were retrieved in real-time from the server computing process 120. In this regard, off-line requests include those network requests which are processed while the client computing device 110 does not enjoy a communicative link with the server computing process 120.

The server computing process 120 can include an off-line server 170, an interactive content processor 200, and a data store of interactive content 180. Specifically, the off-line server 170 can be configured to serve content to a specified depth to the off-line client 140 across the network 130. To that end, the off-line server further can retrieve and serve additional content based upon annotations located within the content. In particular, the interactive content processor 200 can annotate the interactive content 180 with directives and hyperlinks before routing the same to the off-line server 170. The hyperlinks can consolidate a listing of hyperlinks accessible through the content. The directives, by comparison, can provide instructions for selective handling of the hyperlinks by the off-line server 170 when serving the annotated interactive content 180 to the off-line client process 140.

In operation, the off-line client process 140 can request the configured initial page of the interactive content 180 (a server-side Web application, for example) through the off-line server process 170. The off-line server process 170, preferably a servlet implemented component, can request the initial page on behalf of the off-line client process 140, for instance by answering an authentication challenge such as HTTP Basic Auth. Once a session has been established with the interactive content 180, the off-line server process 170 can return to the off-line client process 140 the initial page and a set of page hyperlinks which are to be subsequent requested by the off-line client process 140.

As an example, the set of page hyperlinks can be implemented as an annotated comment to the content disposed at the top portion of the content page:
<!--<offlineServer>
<version>3</version>
<statuscode>200</statuscode>
<session>L2W5CSO2R343ZII</session>
<weburl>/OfflineServer/Do?index=daefc&session=L2W5CSO2R343ZII</weburl>
<weburl>/OfflineServer/Do?index=d0093&session=L2W5CSO2R343ZII</weburl>
</offlineServer>-->
<html>
...
</html>
   Importantly, the foregoing annotation can minimize the parsing required by the off-line client process 140 to retrieve the referenced hyperlinked content. Moreover, the annotation can facilitate the redirection of the off-line client process 140 to the off-line server process 170. In any case, the off-line client 140 can continue to retrieve referenced content placing the content in the cache storage 150 until the off-line server process 170 no longer returns hyperlinks in the annotation for retrieval by the off-line client process 140.

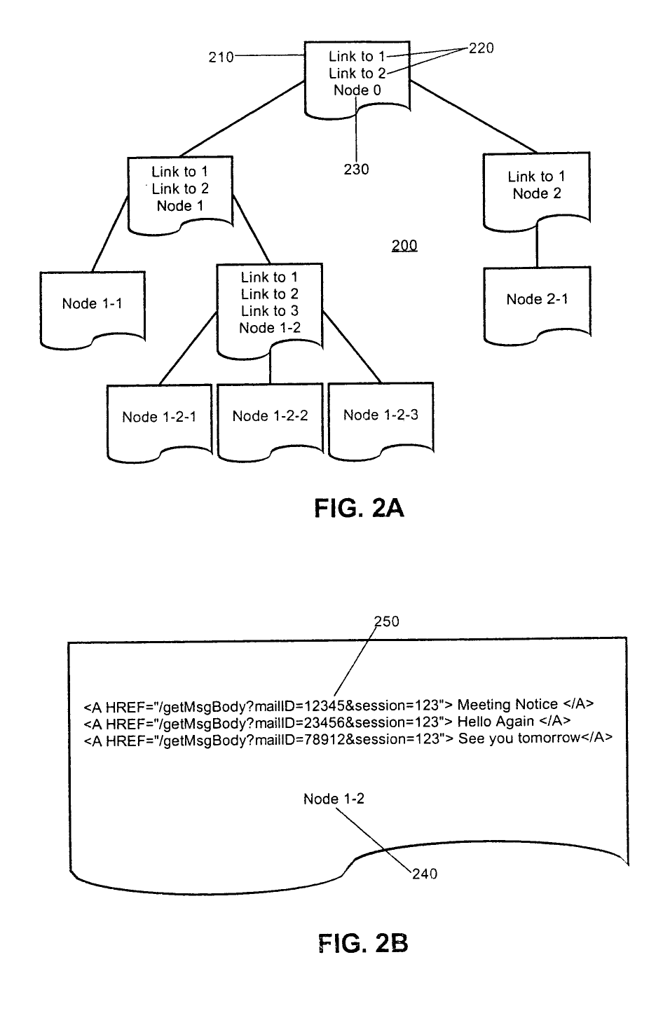

During the process of retrieving content through annotated references to hyperlinked content, the interactive content processor 200 can generate a PNM. More particularly, the PNM can be generated to facilitate the submission of off-line forms regardless of the addressability of embedded hyperlinks. In further illustration, FIG. 2A is a pictorial illustration of a pathway navigation map for use in the system of FIG. 1. As it will be recognized by the skilled artisan, a PNM can include a document tree 260 having multiple nodes 210. Each node 210 in the PNM can include a parent pathway relationship 230 along with a current link or links 220 to be traversed. Consequently, to navigate to any document within the content, one need only consult the PNM to traverse to the specified document.

Notably, dynamically generated documents within a content set rarely maintain absolute link positioning. That is, constructs within the document, such as lists or tables, usually contribute to offsets in the actual link positioning. Thus, an additional level of intelligence can be incorporated into the PNM in accordance with inventive arrangements. Specifically, the document in the content set can be fragmented into logical navigation sets, where each navigational set can represent either an absolute pathway link or a variable sized set of pathway links. Subsequently, an additional element of the hyperlink can be processed in the interactive content processor 200 of FIG. 1 to identify with some specificity, a particular hyperlink in the local navigation set. Using pattern matching, the particular hyperlink can be located in the PNM though the arrangement of the hyperlinks in the set may have changed.

For example, a list of links defined using the well-known markup language tag <UL> or <TABLE> can represent a PNM set. Additionally, the links within a PNM set can be ambiguous. That is, if the list contains a set of hyperlinks to respective unread e-mail messages, the ordering of the hyperlinks can vary as e-mail messages are deleted, for example. To accommodate the contingency of a different arrangement of hyperlinks in a fragmented navigation set, the interactive content processor 200 can rely upon the additional element to identify the particular page in the PNM. In this regard, FIG. 2B is an exploded view of the node 240 having a fragmented navigation set 250 in the pathway navigation map of FIG. 2A. In the exemplary illustration, the “mailD” element can be used to definitively identify the appropriate hyperlink when navigating the PNM of FIG. 2A to find the appropriate pathway.

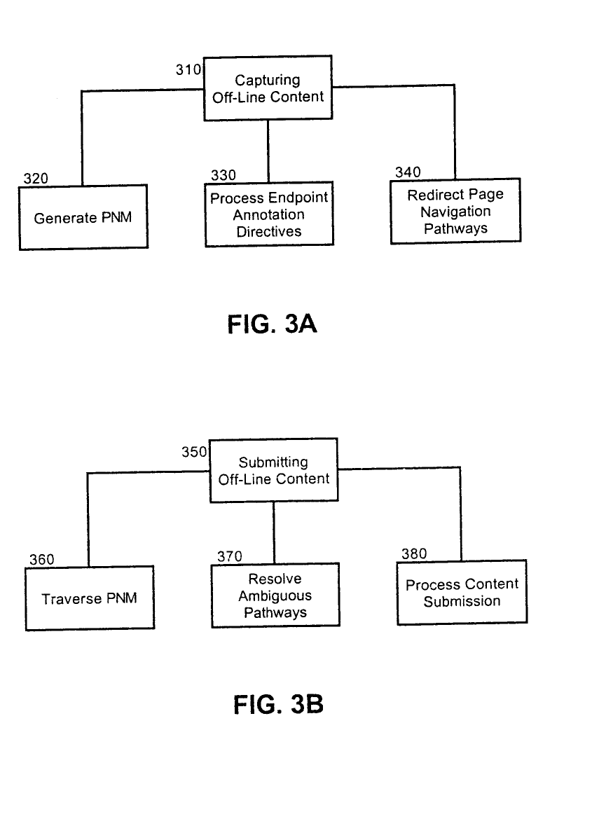

In accordance with the present invention, a process for handling interactive off-line content in view of variable addressability of hyperlinks in the content can include six general steps shown in the block diagrams of FIGS. 3A and 3B. Specifically, FIG. 3A depicts a process 310 for capturing off-line content in the system of FIG. 1, while FIG. 3B depicts a process 350 of submitting interactive off-line content in the system of FIG. 1. Beginning first with FIG. 3A, the process 310 can include in block 320 the generation of a PNM for an interactive content set such as a Web application. Subsequently, pathway endpoint annotation directives can be processed in block 330. Finally, page navigation pathways can be redirected in block 340.

In reference to the processing of pathway endpoint annotation directives in block 330, the directives can be incorporated as HTML comments in the content. The directives can specify particular instructions for handling different types of terminal links such as page refresh links. As the skilled artisan will recall, the plain processing of a page refresh link can extract a heavy toll on low bandwidth communicative links while providing no off-line benefit. To address the foregoing, the annotated directives can take the following form:
<!--offline id=“name” depth=“#” action=“none|remove|deactivate|this|parent”-->
....
<!—\offline—>
   where the id attribute of the directive specifies a universally unique identifier for the directive, the depth attribute overrides the globally configured off-line depth such that when reached, the action can be invoked upon the content.

In this regard, the action attribute can specify a range of actions include the removal of the content (which would be appropriate for a “refresh” tag. The range of actions also can include the deactivation of the tag through, for example, the removal of all <a href> links within the offline tags. The deactivation action can be apropos where a hyperlink has no meaning in the off-line environment. The “this” action can point the cache to the same page for any links disposed within the offline tags. Finally, the parent action can point the cache to the parent page for any hyperlinks disposed within the offline tags. In any event, any content between the offline tags can have the directive and selected action applied to that content disposed between the offline tags.

As shown in FIG. 3B, once disposed in the cached, one can interact with the content off-line and one can submit data collected through the content set. Upon submission, first the PNM can be traversed in block 360 and ambiguous pathways can be resolved in block 370. Specifically, pattern matching methodologies can be applied in respect to specified elements in the hyperlink to definitively identify a specific hyperlink in the PNM. Finally, the content submission can be processed in block 380. More particularly, the content referenced by the hyperlinks in the submission can be reconciled with a current state of the content in the server through the nodes of the PNM.

It will be recognized by the skilled artisan that the environmental constraints of off-line interaction with dynamic content present a considerable challenge to the synchronization of off-line submissions. Nevertheless, by combining the generation of the PNM along with the resolution of ambiguities in the navigation pathway and the processing of specific endpoint annotation directives, the constraints of the prior art can be overcome. Furthermore, by way of the present invention off-line content submissions can be processed with a level of efficiency heretofore which had not been possible.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method for processing off-line interactive content in a dynamic system with variable addressability, the method comprising the steps of:
serving content for caching in a client device;
generating a pathway navigation map (PNM) for said served content; and,
annotating said served content with endpoint directives for modifying hyperlink behavior referenced by said directives in said cached content.

2. The method of claim 1, wherein said generating step comprises the steps of:
forming a document tree having a plurality of nodes;
assigning each node of said tree to a document in said content accessible through a hyperlink referenced by a parent node; and,
disposing within each node a set of hyperlink references to child pages in said content and a reference to a pathway to a root node of said document tree.

3. The method of claim 1, wherein said annotating step comprises the step of annotating said content with at least one endpoint directive selected from the group consisting of take no action, remove all hyperlinks referenced by said directive, deactivate all hyperlinks referenced by said directive, point all hyperlinks referenced by said directive to a currently loaded page; and point all hyperlinks referenced by said directive to a parent page.

4. The method of claim 1, wherein said annotating step comprises the step of annotating said served content with at least one endpoint directive to invoke an action modifying all hyperlinks referenced by said directive when a specified depth within said content has been reached.

5. The method of claim 3, wherein said annotating step comprises the step of annotating said served content with at least one endpoint directive to invoke an action modifying all hyperlinks referenced by said directive when a specified depth within said content has been reached.

6. The method of claim 1, further comprising the step of processing off-line submissions of content by navigating said PNM to reconcile on-line changes in hyperlinks in said content.

7. The method of claim 6, wherein said processing step further comprises the step of utilizing a specific element of said hyperlinks to reconcile ambiguities generated by changes in hyperlinks in said content.

8. A method for processing off-line interactive content in a dynamic system with variable addressability, the method comprising the steps of:
receiving a request for an initial page of a Web application;
annotating said initial page with a set of hyperlinks referenced within said initial page;
retrieving additional pages associated with said set of hyperlinks and repeating said receiving, annotating and retrieving steps for all hyperlinks referenced within said additional pages;
generating a pathway navigation map for said hyperlinks; and,
processing submitted content produced in an off-line interactive session with said initial page and said additional pages by reconciling hyperlinks in said submitted content by traversing said pathway navigation map.

9. A machine readable storage having stored thereon a computer program for processing off-line interactive content in a dynamic system with variable addressability, the computer program comprising a routine set of instructions for causing the machine to perform the steps of:
serving content for caching in a client device;
generating a pathway navigation map (PNM) for said served content; and,
annotating said served content with endpoint directives for modifying hyperlink behavior referenced by said directives in said cached content.

10. The machine readable storage of claim 9, wherein said generating step comprises the steps of:
forming a document tree having a plurality of nodes;
assigning each node of said tree to a document in said content accessible through a hyperlink referenced by a parent node; and,
disposing within each node a set of hyperlink references to child pages in said content and a reference to a pathway to a root node of said document tree.

11. The machine readable storage of claim 9, wherein said annotating step comprises the step of annotating said content with at least one endpoint directive selected from the group consisting of take no action, remove all hyperlinks referenced by said directive, deactivate all hyperlinks referenced by said directive, point all hyperlinks referenced by said directive to a currently loaded page; and point all hyperlinks referenced by said directive to a parent page.

12. The machine readable storage of claim 9, wherein said annotating step comprises the step of annotating said served content with at least one endpoint directive to invoke an action modifying all hyperlinks referenced by said directive when a specified depth within said content has been reached.

13. The machine readable storage of claim 11, wherein said annotating step comprises the step of annotating said served content with at least one endpoint directive to invoke an action modifying all hyperlinks referenced by said directive when a specified depth within said content has been reached.

14. The machine readable storage of claim 9, further comprising the step of processing off-line submissions of content by navigating said PNM to reconcile on-line changes in hyperlinks in said content.

15. The machine readable storage of claim 14, wherein said processing step further comprises the step of utilizing a specific element of said hyperlinks to reconcile ambiguities generated by changes in hyperlinks in said content.

16. A machine readable storage having stored thereon a computer program for processing off-line interactive content in a dynamic system with variable addressability, the computer program comprising a routine set of instructions for causing the machine to perform the steps of:
receiving a request for an initial page of a Web application;
annotating said initial page with a set of hyperlinks referenced within said initial page;
retrieving additional pages associated with said set of hyperlinks and repeating said receiving, annotating and retrieving steps for all hyperlinks referenced within said additional pages;
generating a pathway navigation map for said hyperlinks; and,
processing submitted content produced in an off-line interactive session with said initial page and said additional pages by reconciling hyperlinks in said submitted content by traversing said pathway navigation map.

17. A system for processing off-line interactive content in a dynamic system with variable addressability comprising:
an off-line server process configured for coupling to an off-line client process across an occasionally connected network;
Web application content defined by a plurality of documents; and,
an interactive content processor configured to serve content for caching by said client process, to generate a pathway navigation map (PNM) for said served content; and, to annotate said served content with endpoint directives for modifying hyperlink behavior referenced by said directives in said cached content.
